(19) United States
(12) Patent Application Publication
(10) Pub. No.: US 2010/0043243 A1
(43) Pub. Date: Feb. 25, 2010

(54) DIGITAL ANGLE MEASURING DEVICE

(76) Inventors: Guangjin LI, Guilin (CN); Changsong JIANG, Guilin (CN)

Correspondence Address: MATTHIAS SCHOLL, 14781 MEMORIAL DRIVE, SUITE 1319, HOUSTON, TX, 77079, US

(21) Appl. No.: 12/267,562

(22) Filed: Nov. 8, 2008

(30) Foreign Application Priority Data
Aug. 22, 2008 (CN) 200820104498.6

(51) Int. Cl. B43L 7/10

(52) U.S. Cl. 33/471

(57) ABSTRACT

Provided is a digital angle measuring device, comprising an upper ruler having a first center hole, a lower ruler having a second center hole, a capacitive gate angle sensor, a display portion, a connecting base having a through hole, a rotary axis, a locking knob, and a stop screw, wherein the upper ruler and the lower ruler are connected to the rotary axis via the center holes, the display portion is connected to the rotary axis via the through hole, the locking knob is disposed on the connecting base and connected to the rotary axis, and the stop screw is disposed on one end of the rotary axis. The digital angle measuring device is easily installed and cost-effective.

### CROSS-REFERENCE TO RELATED APPLICATIONS

Pursuant to 35 U.S.C. §119 and the Paris Convention Treaty, this application claims the benefit of Chinese Patent Application No. 200820104498.6 filed Aug. 22, 2008, the contents of which are incorporated herein by reference.

### BACKGROUND OF THE INVENTION

1. Field of the Invention

The invention relates to a measuring device, and particularly to a digital angle measuring device.

2. Description of the Related Art

Nowadays, digital angle measuring devices are widely used in manufacturing industries. A conventional digital angle measuring device comprises a mechanical angle measuring device, a sensor and a digital display portion. However, installation of the digital angle measuring device is very complex. Moreover, the digital angle measuring device is very expensive.

### SUMMARY OF THE INVENTION

In view of the above-described problems, it is one objective of the invention to provide a digital angle measuring device that is easily installed and cost-effective.

To achieve the above objectives, in accordance with one embodiment of the invention, provided is a digital angle measuring device, comprising an upper ruler having a first center hole, a lower ruler having a second center hole, a capacitive gate angle sensor, a display portion, a connecting base having a through hole, a rotary axis, a locking knob, and a stop screw, wherein the upper ruler and the lower ruler are connected to the rotary axis via the center holes, the display portion is connected to the rotary axis via the through hole, the locking knob is disposed on the connecting base and connected to the rotary axis, and the stop screw is disposed on one end of the rotary axis.

In a class of this embodiment or in another embodiment, the center hole of the lower ruler is connected to the rotary axis.

In a class of this embodiment or in another embodiment, a spring is disposed between the center hole of the upper ruler and that of the lower ruler.

In a class of this embodiment or in another embodiment, the connecting base is connected to the upper ruler.

In a class of this embodiment or in another embodiment, the capacitive gate angle sensor has a grid tray, a transmitter and a receiver and employs a three-piece structure, the grid tray is connected to the rotary axis, the transmitter and the receiver are connected to the upper ruler, and the display portion is connected to the transmitter.

In a class of this embodiment or in another embodiment, content on the display portion is normally displayed as the display portion is turned up side down.

In a class of this embodiment or in another embodiment, an upper side of the upper ruler is parallel to a lower side thereof.

In a class of this embodiment or in another embodiment, scale line is marked on the upper ruler.

In a class of this embodiment or in another embodiment, an upper side of the lower ruler is parallel to a lower side thereof.

In a class of this embodiment or in another embodiment, scale line is marked on the upper ruler.

In accordance with another embodiment of the invention, provided is a digital angle measuring device, comprising a pair of rulers each having a first center hole, a capacitive gate angle sensor, a display portion, a connecting base having a through hole, a rotary axis, a locking knob, and a stop screw, wherein the rulers are connected to the rotary axis via the center holes, the display portion is connected to the rotary axis via the through hole, the locking knob is disposed on the connecting base and connected to the rotary axis, and the stop screw is disposed on one end of the rotary axis.

In a class of this embodiment or in another embodiment, the center hole of one of the rulers is connected to the rotary axis.

In a class of this embodiment or in another embodiment, the connecting base is connected to the other ruler.

In a class of this embodiment or in another embodiment, a spring is disposed between the center holes of the rulers.

In a class of this embodiment or in another embodiment, the capacitive gate angle sensor has a grid tray, a transmitter and a receiver and employs a three-piece structure, the grid tray is connected to the rotary axis, the transmitter and the receiver are connected to the upper ruler, and the display portion is connected to the transmitter.

In a class of this embodiment or in another embodiment, content on the display portion is normally displayed as the display portion is turned up side down.

In a class of this embodiment or in another embodiment, an upper side of each of the rulers is parallel to a lower side thereof.

In a class of this embodiment or in another embodiment, scale line is marked on the rulers.

Advantages of the invention comprise:

1) the upper ruler and the lower ruler are normal rulers and feature low cost and high performance;

2) the rotary axis, the spring, the connecting base, the locking knob and the stop screw facilitate reliable axial locking and measurement of 360°, and installation thereof is simple;

3) the invention is multipurpose: can be used as a gauge when being locked at an angle of 90°, and as a prolonged ruler when being locked at a locking angle of 180°, meanwhile, a measuring surface of the prolonged ruler can be used as a positioning surface for marking and processing;

4) the three-piece structure of the capacitive gate angle sensor facilitates frictionless angle measurement and guarantees high and stable measurement precision;

5) the capacitive gate angle sensor features low power consumption, temperature drift and cost, and makes the invention cost-effective.

### BRIEF DESCRIPTION OF THE DRAWINGS

FIG. 1 is a sectional view of a digital angle measuring device of an embodiment of the invention; and

FIG. 2 is a schematic diagram of a digital angle measuring device of an embodiment of the invention.

### DETAILED DESCRIPTION OF THE EMBODIMENTS

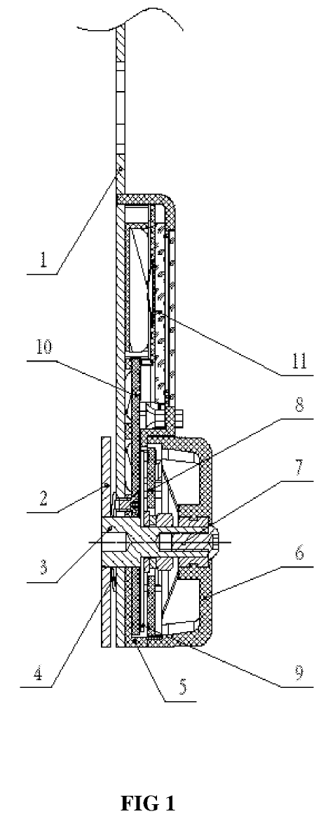

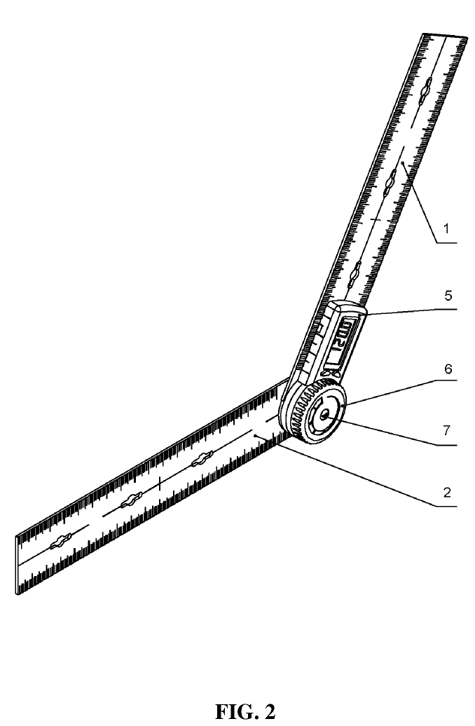

As shown in FIGS. 1 and 2, a digital angle measuring device of the invention comprises an upper ruler 1, a lower ruler 2, a capacitive gate angle sensor, a display portion 11, a connecting base 5, a rotary axis 3, a locking knob 6, and a stop screw 7.

The upper ruler 1 and the lower ruler 2 each has a center hole, and are connected to the rotary axis 3 via the center holes.

An upper side of each of the upper ruler 1 and the lower ruler 2 is parallel to a lower side thereof, and scale line is marked on the upper ruler 1 and the lower ruler 2.

A spring 4 is disposed between the center holes of the upper ruler 1 and the lower ruler 2. In this embodiment, the spring 4 is in a shape of a disk.

The display portion 11 is connected to the rotary axis 3 via the through hole.

The locking knob 6 is disposed on the connecting base 5 and connected to the rotary axis 3. In operation, the locking knob 6 forces the rotating axis 3 to move axially, so that friction is generated between the spring 4 and the upper ruler 1, and thus the upper ruler 1 and the lower ruler 2 can be locked in any position during measurement. The locking knob 6 can be connected to the stop screw 7 in a reverse direction, so as to prevent the locking knob 6 from generating friction as the upper ruler 1 and the lower ruler 2 rotate, and to restrict movement of the locking knob 6.

The stop screw 7 is disposed on one end of the rotary axis 3.

The connecting base 5 is connected to the upper ruler 1, and operates to protect the capacitive gate angle sensor and to transfer locking force on the locking knob 6 to the upper ruler 1. The connecting base 5 has a through hole.

The capacitive gate angle sensor and the display portion 11 are disposed in the connecting base 5.

The display portion 11 is disposed on the upper ruler 1, and content on the display portion 11 is normally displayed as the display portion is turned up side down.

The capacitive gate angle sensor has a grid tray 9, a transmitter 10 and a receiver 8 and employs a three-piece structure.

The grid tray 9 is disposed between the transmitter 10 and the receiver 8, connected to the rotary axis 3, and capable of moving up and down and rotating with respect to a center of each of the transmitter 10 and the receiver 8. In this embodiment, a distance between the transmitter 10 and the receiver 8 is fixed.

The transmitter 10 and the receiver 8 are connected to the upper ruler 1, and the display portion 11 is connected to the transmitter 10.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. A digital angle measuring device, comprising
an upper ruler (1) having a first center hole;
a lower ruler (2) having a second center hole;
a capacitive gate angle sensor;
a display portion (11);
a connecting base (5) having a through hole;
a rotary axis (3);
a locking knob (6); and
a stop screw (7);
wherein
said upper ruler (1) and said lower ruler (2) are connected to said rotary axis (3) via said center holes;
said display portion (11) is connected to said rotary axis (3) via said through hole;
said locking knob (6) is disposed on said connecting base (5) and connected to said rotary axis (3); and
said stop screw (7) is disposed on one end of said rotary axis (3).

2. The digital angle measuring device of claim 1, wherein the center hole of said lower ruler (2) is connected to said rotary axis (3).

3. The digital angle measuring device of claim 1, wherein a spring (4) is disposed between the center hole of said upper ruler (1) and that of said lower ruler (2).

4. The digital angle measuring device of claim 1, wherein said connecting base (5) is connected to said upper ruler (1).

5. The digital angle measuring device of claim 1, wherein
said capacitive gate angle sensor has a grid tray (9), a transmitter (10) and a receiver (8) and employs a three-piece structure;
said grid tray (9) is connected to said rotary axis (3);
said transmitter (10) and said receiver (8) are connected to said upper ruler (1); and
said display portion (11) is connected to said transmitter (10).

6. The digital angle measuring device of claim 1, wherein content on said display portion (11) is normally displayed as said display portion (11) is turned up side down.

7. The digital angle measuring device of claim 1, wherein an upper side of said upper ruler (1) is parallel to a lower side thereof.

8. The digital angle measuring device of claim 1, wherein scale line is marked on said upper ruler (1).

9. The digital angle measuring device of claim 1, wherein an upper side of said lower ruler (2) is parallel to a lower side thereof.

10. The digital angle measuring device of claim 1, wherein scale line is marked on said upper ruler (2).

11. A digital angle measuring device, comprising
a pair of rulers (1, 2) each having a first center hole;
a capacitive gate angle sensor;
a display portion (11);
a connecting base (5) having a through hole;
a rotary axis (3);
a locking knob (6); and
a stop screw (7);
wherein
said rulers (1, 2) are connected to said rotary axis (3) via said center holes;
said display portion (11) is connected to said rotary axis (3) via said through hole;
said locking knob (6) is disposed on said connecting base (5) and connected to said rotary axis (3); and
said stop screw (7) is disposed on one end of said rotary axis (3).

12. The digital angle measuring device of claim 11, wherein the center hole of one of said rulers (1, 2) is connected to said rotary axis (3).

13. The digital angle measuring device of claim 12, wherein said connecting base (5) is connected to the other ruler.

14. The digital angle measuring device of claim 11, wherein a spring (4) is disposed between the center holes of said rulers (1, 2).

15. The digital angle measuring device of claim 11, wherein
said capacitive gate angle sensor has a grid tray (9), a transmitter (10) and a receiver (8) and employs a three-piece structure;
said grid tray (9) is connected to said rotary axis (3);
said transmitter (10) and said receiver (8) are connected to said upper ruler (1); and
said display portion (11) is connected to said transmitter (10).

16. The digital angle measuring device of claim 11, wherein content on said display portion (11) is normally displayed as said display portion (11) is turned up side down.

17. The digital angle measuring device of claim 11, wherein an upper side of each of said rulers (1, 2) is parallel to a lower side thereof.

18. The digital angle measuring device of claim 11, wherein scale line is marked on said rulers (1, 2).
